(19) United States
(12) Patent Application Publication
(10) Pub. No.: US 2024/0354645 A1
(43) Pub. Date: Oct. 24, 2024

(54) DATA LABEL CREATION FROM REDUCED DATA LABELS FOR MODEL TRAINING

(71) Applicant: MASTERCARD TECHNOLOGIES CANADA ULC, Vancouver (CA)

(72) Inventors: Sik Suen Chan, Richmond (CA); Yiqian Liu, Burnaby (CA); Nikolay Shenkov, Burnaby (CA); Carrie Ka Lai Cheung, Vancouver (CA)

(21) Appl. No.: 18/637,643

(22) Filed: Apr. 17, 2024

Related U.S. Application Data
(60) Provisional application No. 63/496,854, filed on Apr. 18, 2023.

(51) Int. Cl. G06N 20/00; G06N 5/01

(52) U.S. Cl. CPC G06N 20/00; G06N 5/01

(57) ABSTRACT

Systems, methods, and non-transitory computer-readable media for creating labels for training a machine learning model using a limited dataset. A label creation application receives raw data from a storage device. The raw data includes requests associated with user accounts. The application determines an account type of each of the user accounts. The application generates a raw data set based on account types, requests, and user accounts. The application cleans the raw data set using client feedback data. The feedback data is the limited dataset that includes fraud events associated with user accounts identified by a client. The application extracts a request history for a user account from the raw data that is cleaned. The application generates a training profile for the user account based on the request history. The application creates training labels based on the training profile, and the model is trained by processing the created labels.

### RELATED APPLICATIONS

This application claims priority to U.S. Provisional Patent Application No. 63/496,854, filed on Apr. 18, 2023, the entire contents of which are hereby incorporated by reference.

### FIELD OF THE INVENTION

The present disclosure relates generally to machine learning. More specifically, the present disclosure relates to systems, methods, and non-transitory computer-readable media for creating labels for training a machine learning model using a limited set of data.

### BACKGROUND

The process of training an ML (machine learning) model involves providing an ML model with training data to learn from. Training data is a labeled set of data that the ML model can learn from to make correct decisions. Data labeling typically starts by asking humans to make judgments about a given piece of unlabeled data. The accuracy of the trained ML model will depend on the accuracy of the labeled dataset, so it is essential to have a highly accurate labeled dataset.

### SUMMARY

Various embodiments of the present disclosure recognize that challenges exist in training an ML model with a set of data with limited volume (also referred to as “limited data”) and that is not complete. For example, training a ML model with incomplete and/or limited data results in the ML model performing unreliably. During the training process, the limited data is used to create a set of labels for training the ML model. However, only limited numbers of labels are produced due to the limited data. To solve the challenges with the limited data, embodiments herein provide heuristic, enhanced, mix-and-match labelling solutions that increase the volume of the limited data and develop a cleaner and more complete data set relative to the limited data.

One embodiment described herein is a system creating labels and training a machine learning model using a limited set of data. The system includes a client device including a first electronic processor and a first memory, a user device including a second electronic processor and a second memory, a storage device including a third electronic processor and a third memory, and a server including a fourth electronic processor and a fourth memory. The fourth memory includes a label creation application. The label creation application receiving raw data from the storage device, wherein the raw data includes a plurality of requests associated with a plurality of user accounts, the plurality of user accounts associated with the user device, wherein the raw data is insufficient for training the machine learning model; determining an account type of each of the plurality of user accounts; generating, using the raw data, a raw data set based on the account types that are determined, the plurality of requests, and the plurality of user accounts; cleaning the raw data set using client feedback data from the client device, wherein the client feedback data is the limited set of data that includes one or more fraud events associated with one or more user accounts and identified by a client, wherein the limited set of data is insufficient for training the machine learning model; extracting a request history for a user account from the raw data that is cleaned; generating a training profile associated with the user account based on the request history that is extracted; creating training labels for training the machine learning model based on the training profile associated with the user account of the raw data that is cleaned; and processing, with the machine learning model, the training profile and the training labels that are created to train the machine learning model.

Another embodiment described herein is a method. The method includes receiving, with a label creation application, raw data from the storage device, wherein the raw data includes a plurality of requests associated with a plurality of user accounts, the plurality of user accounts associated with the user device, wherein the raw data is insufficient for training the machine learning model. The method includes determining, with the label creation application, an account type of each of the plurality of user accounts. The method includes generating, with the label creation application using the raw data, a raw data set based on the account types that are determined, the plurality of requests, and the plurality of user accounts. The method includes cleaning, with the label creation application, the raw data set using client feedback data from the client device, wherein the client feedback data is the limited set of data that includes one or more fraud events associated with one or more user accounts and identified by a client, wherein the limited set of data is insufficient for training the machine learning model. The method includes extracting, with the label creation application, a request history for a user account from the raw data that is cleaned. The method includes generating, with the label creation application, a training profile associated with the user account based on the request history that is extracted. The method includes creating, with the label creation application, training labels for training the machine learning model based on the training profile associated with the user account of the raw data that is cleaned. The method includes processing, with the machine learning model, the training profile and the training labels that are created to train the machine learning model.

Yet another embodiment described herein is a non-transitory computer-readable medium comprising instructions that, when executed by an electronic processor, cause the electronic processor to perform a set of operations. The set of operations includes receiving, with a label creation application, raw data from the storage device, wherein the raw data includes a plurality of requests associated with a plurality of user accounts, the plurality of user accounts associated with the user device, wherein the raw data is insufficient for training the machine learning model. The set of operations includes determining, with the label creation application, an account type of each of the plurality of user accounts. The method includes generating, with the label creation application using the raw data, a raw data set based on the account types that are determined, the plurality of requests, and the plurality of user accounts. The set of operations includes cleaning, with the label creation application, the raw data set using client feedback data from the client device, wherein the client feedback data is the limited set of data that includes one or more fraud events associated with one or more user accounts and identified by a client, wherein the limited set of data is insufficient for training the machine learning model. The set of operations includes extracting, with the label creation application, a request history for a user account from the raw data that is cleaned. The set of operations includes generating, with the label creation application, a training profile associated with the user account based on the request history that is extracted. The set of operations includes creating, with the label creation application, training labels for training the machine learning model based on the training profile associated with the user account of the raw data that is cleaned. The set of operations includes processing, with the machine learning model, the training profile and the training labels that are created to train the machine learning model.

Other aspects of the invention will become apparent by consideration of the detailed description and accompanying drawings.

### BRIEF DESCRIPTION OF THE DRAWINGS

FIG. 1 is a block diagram illustrating an example system for creating labels and training a machine learning model using a limited set of data, in accordance with various aspects of the present disclosure.

FIG. 2 is a block diagram illustrating an example label creation process, in accordance with various aspects of the present disclosure.

FIGS. 3A-3C are example illustrations of client feedback data, in accordance with various aspects of the present disclosure.

FIG. 4 is a conceptual diagram schematically illustrating an example communication or data flow for a labelling process, in accordance with various aspects of the present disclosure.

FIG. 5 is a flow diagram illustrating an example process for creating labels and training a machine learning model using a limited set of data, in accordance with various aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

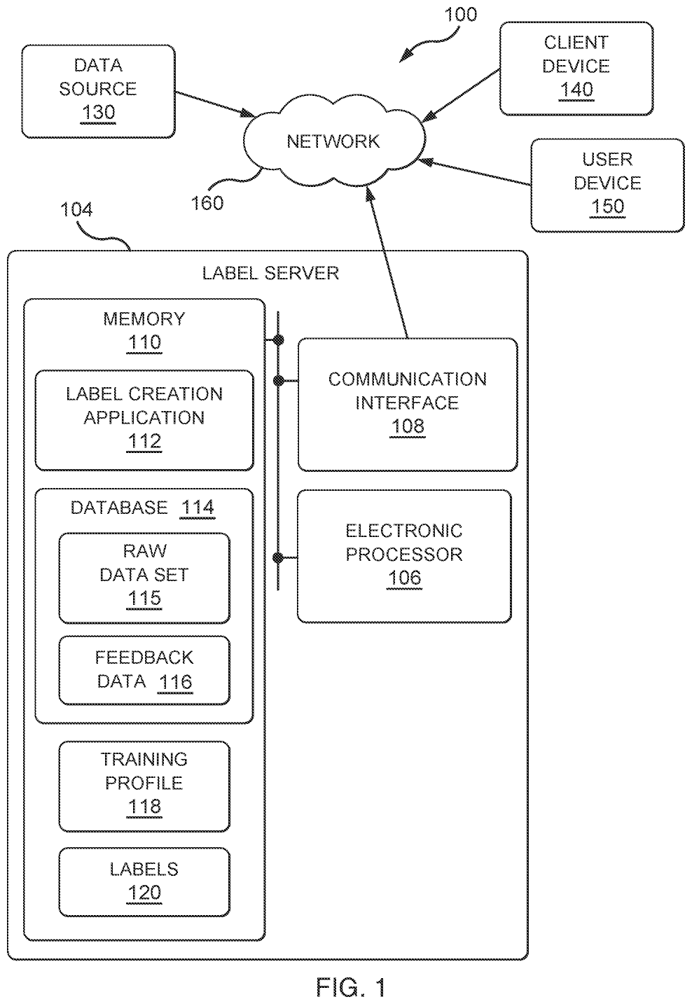

FIG. 1 is a block diagram illustrating an example system for creating labels and training a machine learning model using a limited set of data, in accordance with various aspects of the present disclosure. In the example of FIG. 1, the system 100 includes a label server 104, a data source 130, a client device 140, a user device 150, and a network 160.

The label server 104 may be owned by, or operated by or on behalf of, an administrator. The label server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, et cetera). In some examples, the memory 110 is also a non-transitory computer-readable medium. Although shown within the label server 104, the memory 110 may be, at least in part, implemented as network storage that is external to the label server 104 and accessed via the communication interface 108. For example, all or part of memory 110 may be housed on the “cloud.”

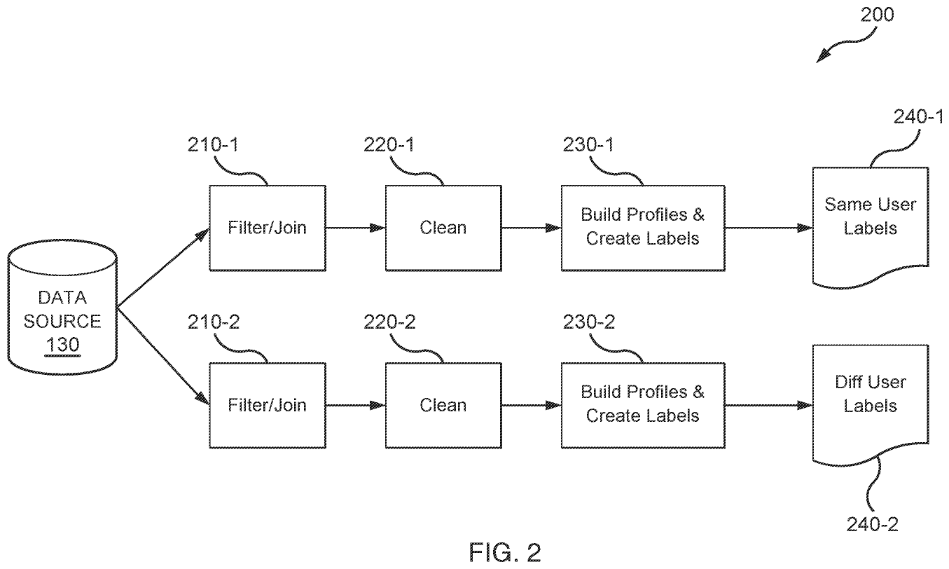

The label creation application 112 may be stored within a transitory or non-transitory portion of the memory 110. The label creation application 112 includes machine readable instructions that are executed by the electronic processor 106 to perform the functionality of the label server 104 as described below with respect to FIGS. 2-5.

The memory 110 may include a database 114 for storing information about user accounts. The database 114 may be an RDF database, i.e., employ the Resource Description Framework. Alternatively, the database 114 may be another suitable database with features similar to the features of the Resource Description Framework, and various non-SQL databases, knowledge graphs, etc. The database 114 may include a plurality of data. The data may be associated with and contain information about an individual user and/or a user account. For example, in the illustrated embodiment, the database 114 includes raw data set 115 and feedback data 116. The raw data set 115 may include a plurality of sets of raw data associated with account users. In some instances, the raw data set 115 is generated based on transactions (e.g., requests) associated with the user device 150, the client device 140, and/or the data source 130. The feedback data 116 may include client data received from the client device 140 associated with account users. In some instances, the feedback data 116 includes fraud information associated with a user account. The memory 110 may also include a training profile 118 and labels 120. The training profile 118 may include a set of historical requests (request history) associated with a user account. The labels 120 may include a set of labeled training examples for training a ML model for generating a score associated with a user.

The data source 130 may be on-premises, cloud, or edge-computing systems providing data and may include an electronic processor in communication with memory. The electronic processor is a microprocessor or another suitable processing device, the memory is one or more of volatile memory and non-volatile memory, and the communication interface may be a wireless or wired network interface. In some examples, the data source 130 may be accessed directly with the label server 104. In other examples, the data source 130 may be accessed indirectly over the network 160. For example, the data source 130 may be a source of transactions associated with a user account transmitted between the user device 150 and the data source 130. In some instances, the transactions include one or more requests of a user account. In some embodiments, the label creation application 112 retrieves data from the data source 130 via the network 160.

The client device 140 may be a web-compatible mobile computer, such as a laptop, a tablet, a smart phone, or other suitable computing device. Alternately, or in addition, the client device 140 may be a desktop computer. The client device 140 includes an electronic processor in communication with memory. The electronic processor is a microprocessor or another suitable processing device, the memory is one or more of volatile memory and non-volatile memory, and the communication interface may be a wireless or wired network interface.

An application, which contains software instructions implemented by the electronic processor of the client device 140 to perform the functions of the client device 140 as described herein, is stored within a transitory or a non-transitory portion of the memory. The application may have a graphical user interface that facilitates interaction between a user and the client device 140.

The client device 140 may communicate with the label server 104 over the network 160. The network 160 is preferably (but not necessarily) a wireless network, such as a wireless personal area network, local area network, or other suitable network. In some examples, the client device 140 may directly communicate with the label server 104. In other examples, the client device 140 may indirectly communicate with the label server 104 over network 160.

The user device 150 may be a web-compatible mobile computer, such as a laptop, a tablet, a smart phone, or other suitable computing device. Alternately, or in addition, user device 150 may be a desktop computer. The user device 150 includes an electronic processor in communication with memory. The electronic processor is a microprocessor or another suitable processing device, the memory is one or more of volatile memory and non-volatile memory, and the communication interface may be a wireless or wired network interface. In an embodiment, the electronic processor of the user device 150 is also in communication with a biometric scanner via a communication interface. In another embodiment, the biometric scanner may be part of the user device 150. The electronic processor is a microprocessor or another suitable processing device, the memory is one or more of volatile memory and non-volatile memory, and the biometric scanner is one or more biometric scanning devices (e.g., a device that scans fingerprints, facial features, irises, handwriting, etc.) now known or subsequently developed.

An application, which contains software instructions implemented by the electronic processor of the user device 150 to perform the functions of the user device 150 as described herein, is stored within a transitory or a non-transitory portion of the memory. The application may have a graphical user interface that facilitates interaction between a user and the user device 150.

The user device 150 may communicate with the label server 104 over the network 160. The network 160 is preferably (but not necessarily) a wireless network, such as a wireless personal area network, local area network, or other suitable network. In some examples, the user device 150 may directly communicate with the label server 104. In other examples, the user device 150 may indirectly communicate with the label server 104 over network 160.

The label server 104 may likewise communicate with partner devices other than the data source 130, the client device 140, and user device 150. The workings of the label server 104, the data source 130, the client device 140, and the user device 150 will now be described in additional detail with respect to FIGS. 2-5.

FIG. 2 is a block diagram illustrating an example label creation process 200, in accordance with various aspects of the present disclosure. In the example of FIG. 2, the label creation application 112 performs the label creation process 200 to create the labels 120. In this example, the label creation process 200 includes two branches. In an embodiment, a first branch of the label creation process 200 is associated with a user account with a single user. The first branch includes a filtering stage 210-1, a cleaning stage 220-1, a building stage 230-1, and same user labels 240-1. A second branch of the label creation process 200 is associated with a user account with different users (e.g., two or more users). The second branch includes a filtering stage 210-2, a cleaning stage 220-2, a building stage 230-2, and different user labels 240-2. The label creation application 112 can perform the first branch or the second branch simultaneously or consecutively.

The label creation application 112 performs the filtering stage 210-1 and the filtering stage 210-2 to create the raw data set 115 using the raw data of the data source 130. In the filtering stage 210-1 and the filtering stage 210-2 the label creation application 112 determines whether user accounts of the raw data are associated with a single user or two or more users using heuristic rules.

In an embodiment, the label creation application 112 determines that an account of the raw data of the data source 130 is a single user account (e.g., account type) using a set of single user heuristic rules. The label creation application 112 applies the set of single user heuristic rules to the raw data generated within a defined time-range (e.g., one hour, one day, one week, one month). The defined time-range may be adjusted based on the number of labels desired and/or the amount of user accounts returned. The set of single user heuristic rules may include a threshold number of login requests for each device type associated with the user account. For example, a user account with greater than or equal to fifteen (15) login requests, which allows the label creation application 112 to create a training profile (e.g., training profile 118) for the user account with the first ten (10) login request and at least five (5) remaining login request for generating labels. The set of single user heuristic rules may include a threshold number of scorable Input Profile Records (IPRs) (e.g., a recorded profile of how a user inputs information into a device or website), a threshold login success rate, login requests with a defined score, a threshold number of unique endpoints (e.g., endpoint is defined as Device FingerPrint Version2 (dfp2)+Internet protocol (IP) address, where neither dfp2 nor endpoint is empty), associated with a single unique IP address, login requests of session are associated with a single unique IP address and username, triggers a first set of informational rules (e.g., related to frequent device, familiar input of keystrokes, familiar input of clicks, frequent geolocations) with login requests, and/or does not trigger a second set of informational (e.g., related to sessions with varying origins, unfamiliar geolocation within a defined time frame, association with an IP aggregator) rules with login requests. The label creation application 112 may also apply additional filters and output a list of single user accounts (e.g., raw data set 115).

In an embodiment, the label creation application 112 determines that an account of the raw data of the data source 130 is a shared user account (e.g., account type) using a set of shared user account heuristic rules (e.g., set of heuristic conditions). The label creation application 112 groups the raw data by account identifiers, time interval-level time bucket, and/or device type to identify sessions and time frames where multiple users were active in the same user account (e.g., account id). The label creation application 112 applies the set of shared user account heuristic rules to the raw data generated within a defined time-range (e.g., one hour, one day, one week, one month, two months). The defined time-range may be adjusted based on the number of labels desired and/or the amount of user accounts returned. The set of shared user heuristic rules may include a defined threshold of active session identifiers (e.g., greater than one (1)), a defined threshold of unique biometric authorization (e.g., greater than one (1) different device fingerprint authorization), a defined threshold of unique user agent, and/or a defined threshold of unique IP address. The label creation application 112 may also output a list of shared user accounts (e.g., raw data set 115). By applying the rules above the label creation application 112 determine whether multiple identifiers are different for requests in the grouped raw data. Each additional identifier that is determined to be different increases the likelihood that the identifiers are associated with two (2) different users in the same account. In addition, the above condition set can be extended with location checks, such as, for example, determining whether the simultaneous sessions within the user account are associated with different time-zones.

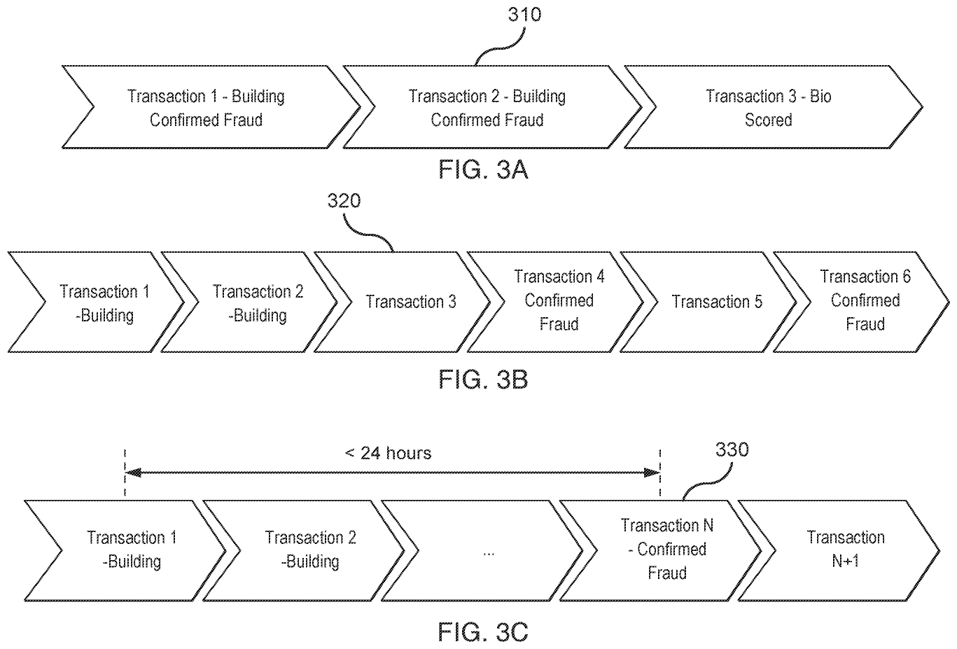

In cleaning stage 220-1 and cleaning stage 220-2 the label creation application 112 cleans the filtered data output from the filtering stage 210-1 and filtering stage 210-2. The label creation application 112 fixes or removes incorrect, corrupt, incorrectly formatted, duplicate, and/or incomplete data within the filtered data. When the data is incorrect, then the outcomes and ML models are unreliable. The feedback data 116 may include client data associated with fraudulent transactions as discussed herein with respect to FIGS. 3A-C. In some instances, the feedback data 116 is a limited set of data that is incomplete or not clean and is not suitable for use to generate an adequate amount of labels to train a ML model.

In an embodiment, the label creation application 112 determines whether an account is suitable for creating labels for training a ML model to score biometrics based on a set of conditions. For example, the label creation application 112 determines whether an account includes at least two (2) non-disqualified and validated transactions in the account's transaction history prior to a first identified fraud event. An account with an account transaction history that includes a first transaction associated with an occurrence of a fraud event cannot be used for labelling purposes due to an insufficient account history to build a trustworthy profile prior to the fraud event. The label creation application 112 assigns a “no match” label to a request of a transaction identified as associated with a fraud event. Also, the label creation application 112 assigns a “match” label to a request of a transaction that occurs prior to a first fraud event in a transaction history of an account, except when the request occurs within a defined time frame (e.g., 30 minutes, a short time frame) before the first fraud event. The request occurring within the defined time frame is considered to be associated with a fraud event. In addition, the label creation application 112 does not consider requests that occur after the first fraud event that are not identified as fraud because there is no confirmation that the fraud has stopped or whether the client simply stopped tracking. In some instances, the feedback data 116 that the client device 140 provides is a limited set and is not adequate to generate a sufficient amount of “same user” labels from the account histories of fraud affected accounts. Therefore, embodiments of the present disclosure use samples from overall traffic to produce “same user” labels. This sampling by the label creation application 112 will use heuristics to identify “good” requests that are likely to be “same user” cases as discussed herein with respect to the filtering stage 210-1 and the filtering stage 210-2. In some instances, the targeted proportion of “same user” to “different user labels” is 95% to 5%.

FIGS. 3A-3C are example illustrations of client feedback data provided by the client device 140, in accordance with various aspects of the present disclosure. FIGS. 3A-3C are described with respect to FIG. 2 to perform enhanced labelling. FIG. 3A includes a transaction history 310 associated with a user account of a shared user account type that includes a plurality of transactions of the feedback data 116. Two transactions of the plurality of transactions are flagged for fraud due to a request of the two transactions being associated with an occurrence of a fraud event by the client device 140. In the cleaning stage 220-2, the label creation application 112 determines that a first transaction (e.g., transaction 1) of the transaction history 310 is associated with fraud and discards the shared user.

FIG. 3B includes a transaction history 320 associated with a user account of a shared user account type that includes a plurality of transactions of the feedback data 116. Two transactions of the plurality of transactions are flagged for fraud due to a request of the two transactions being associated with an occurrence of a fraud event by the client device 140. In the cleaning stage 220-2, the label creation application 112 determines that the transaction history 320 includes at least two (2) non-disqualified and validated transactions (e.g., transaction 1 and transaction 2) and that the shared user account may be used for labelling. However, the label creation application 112 determines that transaction 5 occurs after a fraud event and discards transaction 5. In some instances, the label creation application 112 may label transaction 4 and transaction 6 with a “different user label”.

FIG. 3C includes a transaction history 330 associated with a user account of a shared user account type that includes a plurality of transactions of the feedback data 116. Transaction N of the plurality of transactions is flagged for fraud due to a request of transaction N being associated with a fraud event by the client device 140. In the cleaning stage 220-2, the label creation application 112 determines that the transaction history 320 includes at least two (2) non-disqualified and validated transactions (e.g., transaction 1 and transaction 2). However, the label creation application 112 determines that transaction 1 of the transaction history 330 is within a defined time frame (e.g., 24 hours, same-day) prior to the fraud event of transaction N and that the transactions within the defined time frame may not be used for labelling. The discarded transactions resulting in less data available for label creation. In some implementations, fraud feedback (e.g., feedback data 116) is not used as labels for training because accounts with same-day frauds have distinct characteristics from normal cases.

Returning to FIG. 2, the label creation application 112 performs the building stage 230-1 and the building stage 230-2 to create the training profile 118 using the cleaned data output from the cleaning stage 220-1 and the cleaning stage 220-2. In the building stage 230-1 and the building stage 230-2, the label creation application 112 constructs the training profile 118 for single user accounts and shared user accounts. In the building stage 230-1, the label creation application 112 retrieves a set of the single user accounts output by the cleaning stage 220-1. The label creation application 112 determines a device type associated with each of the single user accounts and generates one or more training profile 118 for each single user account of the set of single user accounts using the requests associated with the account and each device type associated with the account. Additionally, the label creation application 112 labels all transactions/requests of the one or more training profile 118 for each single user account of the set of single user accounts as “same user.” The building stage 230-1 outputs a set of “same user” labels (e.g., the same user labels 240-1).

In the building stage 230-2, the label creation application 112 retrieves a set of requests associated with each user of the shared user accounts output by the cleaning stage 220-2. The label creation application 112 generates one or more training profile 118 for each user of the shared user accounts using the set of requests associated with each user. The label creation application 112 generates the one or more training profile 118 to include a threshold amount of requests (e.g., greater than 10 requests and less than or equal to 100 requests) to manage computation performance. Additionally, the label creation application 112 labels all requests of the one or more training profile 118 for each user of the shared user account as “different user.” The building stage 230-1 outputs a set of “different user” labels (e.g., the different user labels 240-2).

In those embodiments, the label creation application 112 mixes requests paired from different users within the shared user account to create a different user label. The label creation application 112 uses a set of conditions to pair a current request “c” and a match candidate “m”. For example, “c” and “m” must have same account identifiers, “c” and “m” must have different user identifiers, and “c” and “m” must have the same device type. When the above set of condition are satisfied, the label creation application 112 replaces the current IPR of “c” with the current IPR from “m” and label this as a different user request. Matches are identified randomly and up to a certain maximum number of matches (e.g., the maximum number of matches is defined as configurable parameter) and can be used to alter label distributions as required by generating more different user labels.

In some embodiments, in the building stage 230-2 the label creation application 112 generates additional different user request for labelling using a mix-and-match labelling approach. For example, the label creation application 112 generates a historical data set (e.g., [1, 2, 3, 4, 6]) and current data set (e.g., [8, 9]) using the requests associated with different users of the shared account. The label creation application 112 generates a set of training profiles with combinations of the request of the historical data set (e.g., [1, 3, 6], [2, 4, 6], . . . ). In addition, the label creation application 112 pairs a request of the current data set (e.g., 9) with a training profile of the set of training profiles (e.g., [1, 3, 6]) to generate a label. The label creation application 112 generates a plurality of training profiles and labels for training the ML model and prevents fraudulent requests from being included in the historical data set. For example, the label creation application 112 can generate three-thousand and three (3003) unique samples of size ten (10) from a size fifteen (15) historical set. In other embodiments, in the building stage 230-1, the label creation application 112 generates additional different user request for labelling using a mix-and-match labelling approach. For example, the label creation application 112 replaces a training profile of a first single user account with a training profile of a second single user account to generate additional different user labels. In this example, the label creation application 112 combines requests associated with same user labels with request of another single user account to generate additional different user labels.

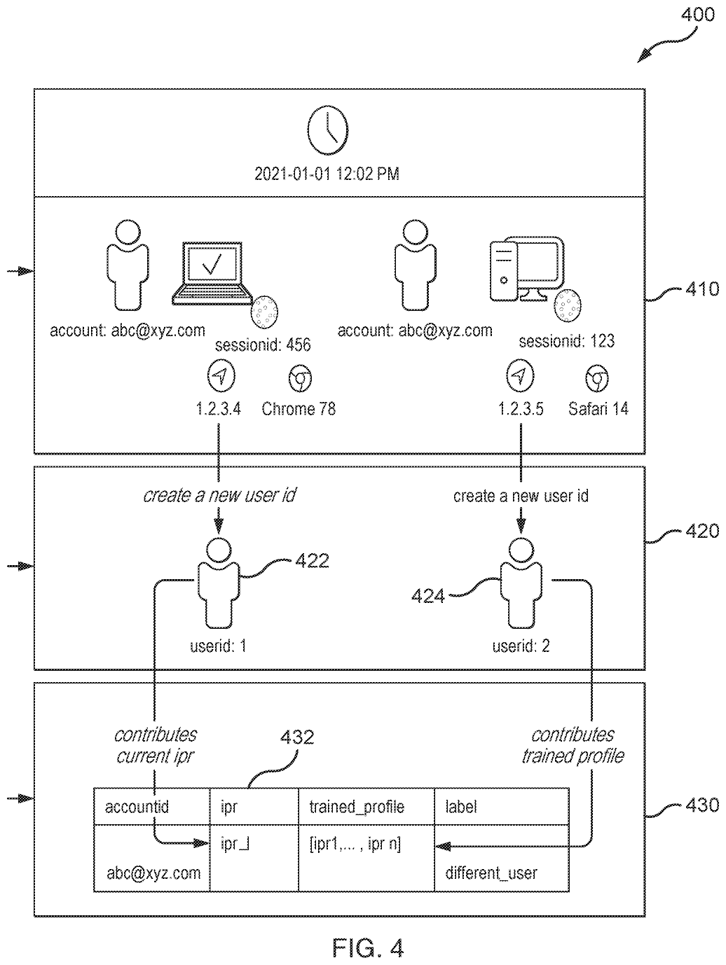

FIG. 4 is an illustration of an example mix-and-match labelling process 400, in accordance with various aspects of the present disclosure. The mix-and-match labelling process 400 includes account identification phase 410, identification phase 420, label phase 430.

In the account identification phase 410, the label creation application 112 determines an account type. The label creation application 112 uses data associated with the account to determine whether the account includes two or more active unique sessions (e.g., sessionid: 123 and sessionid: 456), devices (e.g., laptop and desktop), user agents (e.g., browser type 1 and browser type 2), and IP (e.g., 1.2.3.4 and 1.2.3.5) at the same time (e.g., rounded to the minute). In those instances, when the label creation application 112 determines the account is a shared user account, the label creation application 112 assigns user identifiers to a first user 422 and a second user 424 of the account during the identification phase 420. In the label phase 430, the label creation application 112 generates a record 432. The record 432 is a request for training the ML model, the label creation application 112 generates using the current IPR of the first user 422 and a training profile of the second user 424. Also, the label creation application 112 assigns the request a different user label.

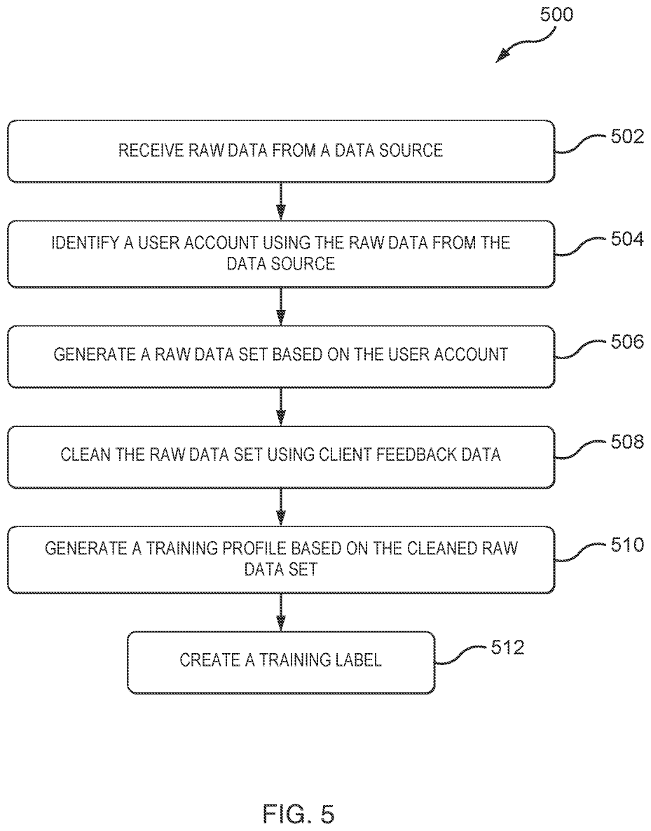

FIG. 5 is a flow diagram illustrating an example process 500 for creating labels and training a machine learning model using a limited set of data, in accordance with various aspects of the present disclosure. In the example of FIG. 5, the process 500 is described in a sequential flow, however, some of the process 500 may also be performed in parallel.

The process 500 receives raw data from a data source (at block 502). For example, the label server 104 receives raw data from the data source 130.

The process 500 identifies a user account using the raw data from the data source (at block 504). For example, the label creation application 112 identifies an account associated with a request of the raw data that is received from the data source 130. In some examples, the label creation application 112 may also determine whether the account is a single user account or a shared user account based on a set of conditions.

The process 500 generates a raw data set based on the user account that is identified (at block 506). For example, the label creation application 112 filters the raw data of the data source 130 using the identified account to generate the raw data set 115.

The process 500 cleans the raw data set using client feedback data (at block 508). For example, the label creation application 112 receives the feedback data 116 from the client device 140. The label creation application 112 removes unreliable and/or inadequate data for training purposes from the raw data set 115 using the feedback data 116.

The process 500 generates a training profile based on the cleaned raw data set (at block 510). For example, the label creation application 112 extracts a set of requests from a user account of the raw data set 115 that is enhanced using the feedback data 116. The label creation application 112 creates the training profile 118 for each set of requests extracted from the user account. In some examples, the label creation application 112 samples the training profile 118 for each set of requests to create subsets of the set of requests. The label creation application 112 generates additional versions of the training profile 118 using the subsets of the set of requests.

The process 500 creates training labels (at block 512). For example, the label creation application 112 appends the labels 120 to each request of an identified account. The labels 120 may include same user labels or different user labels. In an embodiment, the label server inputs the training profile 118 and the labels 120 into the machine learning model. The machine learning models processes the training profile 118 and the labels 120 to train/retrain the machine learning model. In some implementations, the machine learning model is trained to identify fraudulent transactions associated with the user device 150. In other implementations, the machine learning model is trained to identify non-fraudulent accounts associated with requests provided by the user device 150.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. In another example, the expression “approximately 0” may disclose the absence of a value to within at least a degree of reasonable tolerance. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware. Also, if an apparatus, method, or system is claimed, for example, as including a controller, module, logic, electronic processor, or other element configured in a certain manner, for example, to perform multiple functions, the claim or claim element should be interpreted as meaning one or more controllers, modules, logic elements, electronic processors other elements where any one of the one or more elements is configured as claimed, for example, to perform any one or more of the recited multiple functions.

What is claimed is:

1. A system for creating labels and training a machine learning model using a limited set of data, the system comprising:
a client device including a first electronic processor and a first memory;
a user device including a second electronic processor and a second memory;
a storage device including a third electronic processor and a third memory, the storage device associated with the client device and the user device; and
a server including a fourth electronic processor and a fourth memory including a label creation application, the fourth electronic processor configured to:
receive raw data from the storage device, wherein the raw data includes a plurality of requests associated with a plurality of user accounts, the plurality of user accounts associated with the user device, wherein the raw data is insufficient for training the machine learning model,
determine, with the label creation application, an account type of each of the plurality of user accounts,
generate, with the label creation application using the raw data, a raw data set based on the account type that is determined, the plurality of requests, and the plurality of user accounts,
clean, with the label creation application, the raw data set using client feedback data from the client device, wherein the client feedback data is the limited set of data that includes one or more fraud events associated with one or more user accounts and identified by a client, wherein the limited set of data is insufficient for training the machine learning model,
extract, with the label creation application, a request history for a user account from the raw data that is cleaned,
generate, with the label creation application, a training profile associated with the user account of the raw data based on the request history that is extracted,
create, with the label creation application, training labels for training the machine learning model based on the training profile associated with the user account of the raw data that is cleaned, and
process, with the machine learning model, the training profile and the training labels that are created to train the machine learning model.

2. The system of claim 1, wherein determining the account type of each of the plurality of user accounts, the fourth electronic processor is further configured to:
determine a first user account of the plurality of user accounts is associated with a single user based on a set of heuristic conditions associated with identifying accounts used by a single user, and
assign the first user account of the plurality of user accounts a first account type that is associated with single user accounts.

3. The system of claim 2, wherein creating training labels for training the machine learning model, the fourth electronic processor is further configured to:
determine a device type associated with the user account, and
create a request associated with the user account by replacing a first device type associated with a first request with a second device type associated with the user account, and
assign a label to the request that is created.

4. The system of claim 1, wherein determining the account type of each of the plurality of user accounts, the fourth electronic processor is further configured to:
determine a second user account of the plurality of user accounts is associated with two or more users based on a set of heuristic conditions associated with identifying accounts shared by users, and
assign the second user account a second account type that is associated with a shared user account.

5. The system of claim 4, wherein cleaning the raw data set using client feedback data, the fourth electronic processor is further configured to:
identify, using the client feedback data, a third user account of the one or more user accounts that is associated with an occurrence of a fraud event of the one or more fraud events, and
remove the third user account of the one or more user accounts from the raw data set based on the fraud event and transaction of the third user account, wherein the third user account is not valid for training the machine learning model.

6. The system of claim 4, wherein creating training labels for training the machine learning model, the fourth electronic processor is further configured to:
create a request associated with a first user of the two or more users by replacing a first request associated with an identifier of the first user with a second request associated with an identifier of a second user of the two or more users, and
assign a label to the request that is created.

7. The system of claim 1, wherein generating the raw data set, the fourth electronic processor is further configured to:
filter the raw data using a set of heuristic conditions, and
create a subset of the raw data using the raw data that satisfies the set of heuristic conditions.

8. A method for creating labels for training a machine learning model using a limited set of data, the method comprising:
receiving, with a label creation application, raw data from a storage device, wherein the raw data includes a plurality of requests associated with a plurality of user accounts, the plurality of user accounts associated with a user device, wherein the raw data is insufficient for training the machine learning model,
determining, with the label creation application, an account type of each of the plurality of user accounts,
generating, with the label creation application using the raw data, a raw data set based on the account type that is determined, the plurality of requests, and the plurality of user accounts,
cleaning, with the label creation application, the raw data set using client feedback data from a client device, wherein the client feedback data is the limited set of data that includes one or more fraud events associated with one or more user accounts and identified by a client, wherein the limited set of data is insufficient for training the machine learning model,
extracting, with the label creation application, a request history for a user account from the raw data that is cleaned,
generating, with the label creation application, a training profile associated with the user account of the raw data based on the request history that is extracted,
creating, with the label creation application, training labels for training the machine learning model based on the training profile associated with the user account of the raw data that is cleaned, and
processing, with the machine learning model, the training profile and the training labels that are created to train the machine learning model.

9. The method of claim 8, wherein determining the account type of each of the plurality of user accounts, the method further comprises:
determining a first user account of the plurality of user accounts is associated with a single user based on a set of heuristic conditions associated with identifying accounts used by a single user, and
assigning the first user account of the plurality of user accounts a first account type that is associated with single user accounts.

10. The method of claim 9, wherein creating training labels for training the machine learning model, the method further comprises:
determining a device type associated with the user account, and
creating a request associated with the user account by replacing a first device type associated with a first request with a second device type associated with the user account, and
assigning a label to the request that is created.

11. The method of claim 8, wherein determining the account type of each of the plurality of user accounts, the method further comprises:
determining a second user account of the plurality of user accounts is associated with two or more users based on a set of heuristic conditions associated with identifying accounts shared by users, and
assigning the second user account a second account type that is associated with a shared user accounts.

12. The method of claim 11, wherein cleaning the raw data set using client feedback data, the method further comprises:
identifying, using the client feedback data, a third user account of the one or more user accounts that is associated with an occurrence of a fraud event of the one or more fraud events, and
removing the third user account of the one or more user accounts from the raw data set based on the fraud event and transaction of the third user account, wherein the third user account is not valid for training the machine learning model.

13. The method of claim 11, wherein creating training labels for training the machine learning model, the method further comprises:
creating a request associated with a first user of the two or more users by replacing a first request associated with an identifier of the first user with a second request associated with an identifier of a second user of the two or more users, and
assigning a label to the request that is created.

14. The method of claim 8, wherein generating the raw data set, the method further comprises:
filtering the raw data using a set of heuristic conditions, and
creating a subset of the raw data using the raw data that satisfies the set of heuristic conditions.

15. A non-transitory computer-readable medium comprising instructions for creating labels for training a machine learning model using a limited set of data that, when executed by an electronic processor, cause the electronic processor to perform a set of operations comprising:
receiving raw data from a storage device, wherein the raw data includes a plurality of requests associated with a plurality of user accounts, the plurality of user accounts associated with a user device, wherein the raw data is insufficient for training the machine learning model,
determining an account type of each of the plurality of user accounts,
generating, using the raw data, a raw data set based on the account type that is determined, the plurality of requests, and the plurality of user accounts,
cleaning the raw data set using client feedback data from a client device, wherein the client feedback data is the limited set of data that includes one or more fraud events associated with one or more user accounts and identified by a client, wherein the limited set of data is insufficient for training the machine learning model,
extracting a request history for a user account from the raw data that is cleaned,
generating a training profile associated with the user account of the raw data based on the request history that is extracted,
creating training labels for training the machine learning model based on the training profile associated with the user account of the raw data that is cleaned, and
processing, with the machine learning model, the training profile and the training labels that are created to train the machine learning model.

16. The non-transitory computer-readable medium of claim 15, wherein determining the account type of each of the plurality of user accounts, further comprises:
determining a first user account of the plurality of user accounts is associated with a single user based on a set of heuristic conditions associated with identifying accounts used by a single user, and
assigning the first user account of the plurality of user accounts a first account type that is associated with single user accounts.

17. The non-transitory computer-readable medium of claim 16, wherein creating training labels for training the machine learning model, further comprises:
determining a device type associated with the user account, and
creating a request associated with the user account by replacing a first device type associated with a first request with a second device type associated with the user account, and
assigning a label to the request that is created.

18. The non-transitory computer-readable medium of claim 15, wherein determining the account type of each of the plurality of user accounts, further comprises:
determining a second user account of the plurality of user accounts is associated with two or more users based on a set of heuristic conditions associated with identifying accounts shared by users, and
assigning the second user account a second account type that is associated with a shared user accounts.

19. The non-transitory computer-readable medium of claim 18, wherein cleaning the raw data set using client feedback data, further comprises:
identifying, using the client feedback data, a user account of the one or more user accounts that is associated with an occurrence of a fraud event of the one or more fraud events, and
removing the user account of the one or more user accounts from the raw data set based on the fraud event and transaction of the user account, wherein the user account is not valid for training the machine learning model.

20. The non-transitory computer-readable medium of claim 18, wherein creating training labels for training the machine learning model, further comprises:
creating a request associated with a first user of the two or more users by replacing a first request associated with an identifier of the first user with a second request associated with an identifier of a second user of the two or more users, and
assigning a label to the request that is created.
